(19) United States
(12) Patent Application Publication
(10) Pub. No.: US 2005/0193378 A1
(43) Pub. Date: Sep. 1, 2005

(54) System and method for building an executable program with a low probability of failure on demand

(76) Inventor: Richard E. Breault, San Juan Capistrano, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/790,668

(22) Filed: Mar. 1, 2004

(51) Int. Cl. G06F 9/45

(52) U.S. Cl. 717/140

(57) ABSTRACT

A system and method for building a program (e.g., a control program) for execution by a programmable controller from a source program. The source program, which includes instructions in a high-level programming language (e.g., structured text, C++, Pascal or graphics oriented languages), is separately converted into a first and second processor-executable programs. The first and second processor-executable programs are then compared, and if the first and second processor-executable programs are substantially the same, then one of them is sent to the programmable controller. If they are not substantially the same one of them is corrupt and the conversion process is aborted. In variations, the source program is simultaneously converted into the first and second processor-executable programs using a diversified collection of hardware and software components. In yet other variations, the source program is asynchronously converted so as to temporally separate the conversion of the first and second executable programs.

### BACKGROUND OF THE INVENTION

1. Field of the Invention

The present invention relates generally to control and monitoring systems, and more specifically to building software for industrial safety, reliability, and monitoring systems.

2. Discussion of the Related Art

Modern industrial systems and processes tend to be technically complex, involve substantial energies and monetary interests, and have the potential to inflict serious harm to persons or property during an accident. Although absolute protection may not be possible to achieve, risk can be reduced to an acceptable level using various methods to increase an industrial system's safety and reliability and mitigate harm if an event, e.g., a failure, does occur.

In the context of safety systems, one of these methods includes utilization of one or more safety instrumented systems (SIS). A safety instrumented system (SIS) is an instrumented system used to implement one or more safety instrumented functions (SIF), for the purposes of: taking an industrial process to a safe state when specified conditions are violated; permitting a process to move forward in a safe manner when specified conditions allow (permissive functions); and/or taking action to mitigate the consequences of an industrial hazard.

A safety instrumented function (SIF) is a function implemented by a SIS, which is intended to achieve or maintain a safe state for a process with respect to a specific event, e.g., a hazardous event. Hardware to carry out the SIF typically includes a programmable safety controller and a collection of sensors and actuators for detecting and reacting to events, respectively. An important component of a SIF are the control programs that direct the operations of the programmable safety controller.

To direct appropriate design and planned maintenance of a SIF, safety standards bodies have established a system that defines several Safety Integrity Levels (SIL) that are appropriate for a SIF depending upon the consequences of the SIF failing on demand. According to the International Electrotechnical Commision (IEC) standard 61508, safety integrity level (SIL) is a measure of the risk reduction provided by a SIF based on four discrete levels, each representing an order of magnitude of risk reduction. Each SIL level is associated with a designed average probability of failure on demand (PFD). For example, a SIL 1 means that the maximum probability of failure is 10% (i.e., the SIF is at least 90% available), and a SIL 4 means that the maximum probability of failure is 0.01% (i.e., the SIF is at least 99.99% available).

Consistent with existing, standardized methodology, during design of a safety instrumented system (SIS), safety integrity level (SIL) requirements are established for each SIF based upon the impact of the specific hazardous event that the SIF is intended to prevent. For example, a SIL level of 1 may be assigned to a hazardous event that imparts only minor property damage, whereas a SIL of 4 may be assigned to a SIF that is intended to prevent an event that would produce catastrophic community-wide consequences.

After a SIL is assigned to each SIF, each SIF is designed to operate within the designed average probability of failure on demand (PFD) that corresponds to the SIL assigned to the SIF. Because a SIF is typically implemented with a programmable safety controller, and control programs control the programmable safety controller, it is essential that the control programs operate as expected to maintain the SIL level expected for its associated SIF.

The control programs created for the programmable safety controllers are typically created on a PC or general-purpose computer of a low SIL level and then downloaded to the safety controller which has a high SIL level. The control programs, however, may be corrupted by a variety of transient conditions before being downloaded to the safety controller. The corruption may be caused by memory errors, processor errors, disc controller errors, or any of the many other hardware components of a general-purpose computer.

For example, when building a typical software application, a compiler first converts a source program to an intermediate form, which may be object code, assembly language source code, or some other intermediate form used for optimization or further code generation. The intermediate code (if generated) may then be processed by one or more optimization phases and finally converted to either assembly language or object code files. If assembly language is generated, then the assembly language source code is converted to object code files by an assembler. Finally, all of the object code files are linked together to form the complete executable control progam. This program may then be transformed yet again to a format suitable for download to the safety controller.

The more transformations that are done during the build process the more likely a transient error is to occur. Moreover, the farther along in the build process a transient error occurs the less likely it is that the error will be detected. Problematically, some errors may only affect portions of the control program that are triggered by an event (e.g., a hazardous failure). As a consequence, a corrupted control program may go undiscovered until the safety controller fails to perform when it is needed the most.

### SUMMARY OF THE INVENTION

In one embodiment, the invention may be characterized as a method for building a program for execution by a programmable controller. The method includes: receiving a source program, the source program including high-level instructions for controlling a programmable controller; converting the source program to a first processor-executable program and a second processor-executable program; comparing the first and second processor-executable programs; sending, in response to the first and second processor-executable programs being substantially the same, one of the first and second processor-executable programs to the programmable controller.

In another embodiment the invention may be characterized as a system for generating a control program. The system comprising a processor; a memory associated with the processor, the memory including: conversion code including encoded instructions for separately converting a source program into first and second load modules, the first and second load modules including processor-executable code to control a programmable controller; and comparison code including encoded instructions for comparing the first and second load modules and sending one of the load modules to the programmable controller in response to the first and second load modules being substantially the same.

In yet another embodiment, the invention may be characterized as a processor-readable medium including code to generate a control program from a source program when executed by a processor, the control program being disposed for execution by a programmable controller. The code includes conversion code for converting a source program into the control program; a code segment for loading two copies of at least a portion of the conversion code into a memory associated with the processor such that the two copies do not occupy the same location in the memory; each of the two copies including code to generate a corresponding one of two copies of at least a portion of the control program; comparison code for comparing the two copies of the at least the portion of the control program, and sending at least one of the two copies of the at least the portion of the control program to the programmable controller in response to the two copies of the at least the portion of the control program being substantially the same.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a is a block diagram of an exemplary industrial system in which a redundant build system according to one embodiment of the present invention is implemented;

FIG. 2 is a schematic diagram of an exemplary embodiment of the redundant build module of FIG. 1;

FIG. 3 is a data flow diagram illustrating the interaction among the program modules of the redundant build module of FIG. 2;

FIG. 4 is a flowchart depicting steps carried out by the redundant build module of FIGS. 1 and 2 when building an executable program from a source program;

FIG. 5 is a data flow diagram depicting data flow during a validation of system resources in the redundant build module of FIG. 2; and

FIG. 6 is a flowchart depicting steps carried out during a validation of the redundant build module of FIGS. 1 and 2.

Corresponding reference characters indicate corresponding components throughout the several views of the drawings.

### DETAILED DESCRIPTION

In one aspect, the present invention is directed to a system and method for error avoidance and error checking while building an executable control program from a source program. In an exemplary embodiment, a source program (e.g., a safety control program) is transformed from a high-level programming language (e.g., structured text, C++, Pascal, function block diagram language or ladder diagram language) into executable code using diverse system resources and redundant processing techniques that provide an increased degree of reliability over prior methodologies. Although the redundant build system of the present invention is described in the context of an industrial safety system, it should be recognized that it is not necessarily limited to such implementations.

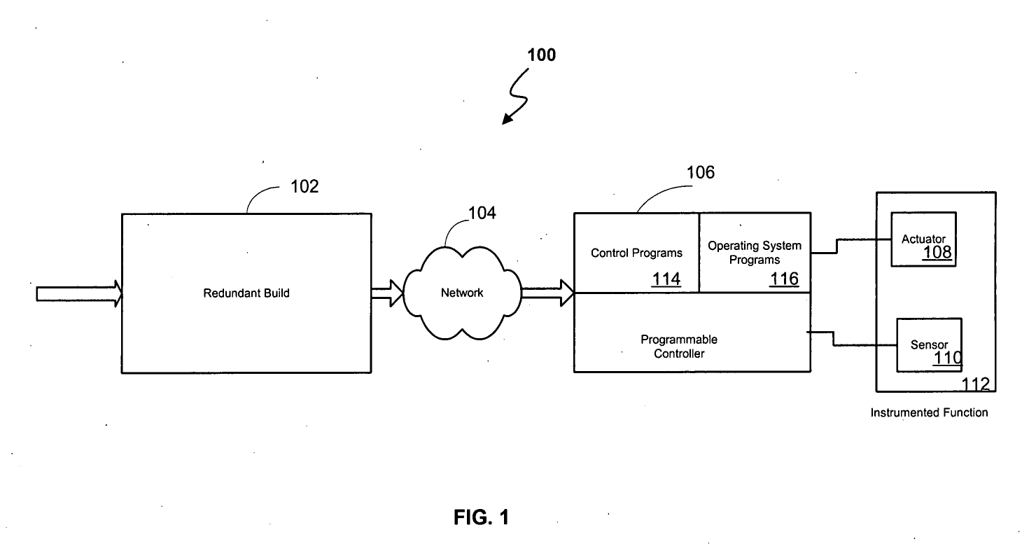

Referring first to FIG. 1, shown is a block diagram of an exemplary industrial system 100 in which a redundant build system according to one embodiment of the present invention is implemented. As shown, a redundant build module 102 is in communication with a programmable controller 106 via a network 104. The programmable controller 106 is coupled to an actuator 108 and a sensor 110, which collectively implement an instrumented function 112, e.g., a safety instrumented function (SIF). Also shown within the programmable controller 106 is a control programs portion 114.

As described further herein, the redundant build module 102 is realized by a combination of software and hardware, which may include one or more general-purpose computers. In the exemplary embodiment, the redundant build module 102 is configured to receive and convert a source program from a high-level programming language (e.g., structured text, an IEC 1131 compliant language, C++, Pascal or graphics oriented languages) into a processor-executable program (e.g., a control program or operating-system program) that has a low probability of failing when executed. The redundant build module 102 then sends the executable program via the network 104 (e.g., a combination wired and/or wireless LANs, WANs, and/or the Internet) to the programmable controller 106.

The programmable controller 106 may be realized using any one of a variety of devices, which have input/output (I/O) functionality, contain a processor (e.g., a CPU) and memory. The programmable controller 106 may be, for example and without limitation, an intelligent field device, a safety controller, a programmable logic controller (PLC), a general-purpose computer or potentially any other device that includes a processor, memory and input/output capability.

In the exemplary embodiment, the instrumented function 112 represents a specific safety function executed by the actuator 108 and sensor 110 to achieve or maintain a safe state for a process with respect to a specific event, e.g., a hazardous event. The sensor 110 and actuator 108, also referred to herein as instrumented function components, respectively monitor and react in cooperation with the programmable controller 106 to process conditions in the industrial system 100 in order to help ensure that the instrumented function 112 is carried out on demand. Although one sensor 110 and one actuator 108 are shown for simplicity, it should be recognized that there are potentially multiple actuators and sensors associated with a particular instrumented function, e.g., a particular safety instrumented function (SIF). One of ordinary skill in the art will recognize that there are several varieties of both sensors and actuators. In one embodiment, for example, the sensor 110 is a pressure sensor and the actuator 108 controls a shut off valve.

It should be recognized that the programmable controller 106 may be integrated with the actuator 108 and/or the sensor 110. In one embodiment for example, a safety-instrumented system is implemented with several intelligent field devices, and each intelligent field device includes a programmable controller 106. In this embodiment, the redundant build module 102 directs processor-executable programs (e.g., executable function blocks) to the appropriate intelligent field device via the network 104, which may operate according to Foundation Fieldbus™ protocols. Additional information about downloading executable programs to intelligent field devices may be found within the document entitled: Foundation™ Specification System Management Addendum for Software Download (Document FF-883), dated Oct. 8, 2003, which is incorporated herein by reference.

It should also be recognized that the programmable controller 106 may be implemented in a redundant manner so that two or more programmable controllers 106 receive and carry out the same executable program. In one embodiment for example, the programmable controller 106 is redundantly realized by triplicated main processor modules (MPs) within a control system (not shown) having a triple modular redundant (TMR) architecture. In this embodiment, the redundant build module 102 sends the executable program via the network 104 to a communication module within the control system, and the communication module forwards the executable program to each of the three MPs. Details of a TMR system that may be used in the present embodiment are disclosed in U.S. Pat. No. 6,449,732 to Rasmussen et al., which is incorporated herein by reference. It should be recognized that a TMR system is merely exemplary of the redundant modular controllers the present invention applies to, and that the present invention may be used with control systems with any level of redundancy.

Within the programmable controller 106 is shown a control programs portion 114, which includes executable control programs that are read from a memory and carried out by a processor (not shown) of the programmable controller 106. The control programs portion 114 includes control programs that are specifically designed to monitor the instrumented function 112 (e.g., via the sensor 110) for events (e.g., high pressure) and make adjustments (e.g., via the actuator) to mitigate the hazardous effects of any events. Also shown is an operating-system portion 116, which includes executable operating-system code that is executed by the processor (not shown) of the programmable controller 106 to provide the programmable controller 106 with instructions to carry out low-level operations.

In operation, the redundant build module 102 receives a source representation of a control program (referred to herein as a source program) written in a high-level programming language and separately converts (e.g., separately in terms of time and/or by system resources) the source program into two processor-executable programs (e.g., executable machine language representations). The redundant build module 102 compares the processor-executable programs, and if there are any substantial differences between them (i.e., differences that indicate one of the processor executable programs may not operate properly), then the download process is aborted. If the two processor-executable programs are substantially the same, then one is chosen and downloaded via the network 104 to the programmable controller 106.

Although it is possible that a chronic system error in the redundant build module 102 may manifest itself in exactly the same way in each of the two processor-executable programs, and hence go undetected, a process of validating the redundant build module 102 helps to reduce the likelihood that such a chronic error will go undetected. For example, the redundant build module 102 in an exemplary embodiment is validated by converting a reference source program into a test program and comparing the test program with a reference executable program, which is known to be without faults. If the test program is not the same as the reference executable program, then there is likely a fault within the redundant build module 102. The user is then aware that any executable programs generated by the redundant build module 102 may have an error.

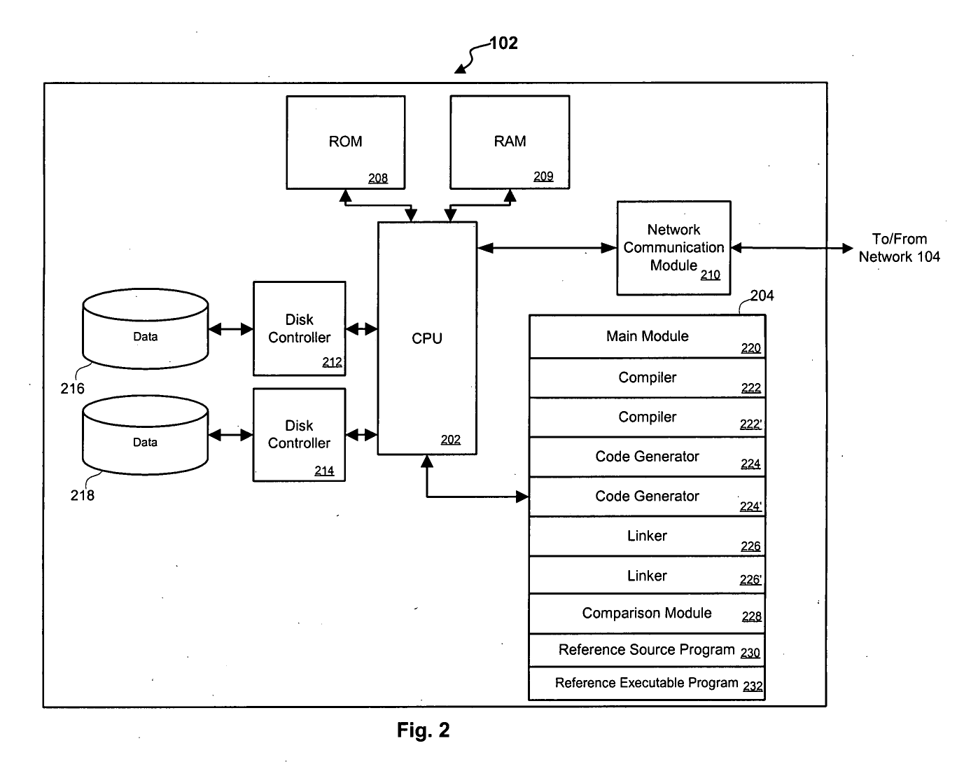

Referring next to FIG. 2, shown is a schematic diagram of an exemplary embodiment of the redundant build module 102 of FIG. 1 realized by a single general-purpose computer. The redundant build module 102 includes a CPU 202 connected to memory 204, ROM 208, RAM 209 a network communication module 210 and first and second hard drive controllers 212, 214. As shown, the first and second hard drive controllers 212, 214 are coupled respectively to first and second hard drives 216, 218. Within the memory 204 are program modules with conversion code for converting a source program into two or more of the same processor-executable programs.

In the present embodiment, the conversion code includes encoded instructions distributed by function among a first compiler 222, a second compiler 222′, a first code generator 224, a second code generator 224′, a first linker module 226 and a second linker module 226′. The memory 204 also includes a copy of the operating system for the redundant build module 102 (not shown). When effecting the functionality described herein with reference to FIGS. 2-6, the CPU 202 loads into RAM 209 and executes one or more of the program modules stored within memory 204. As one of ordinary skill in the art will appreciate, the memory 204 may be realized by one or more of a variety of storage mediums including one, or both, of the hard drives 216, 218.

When executed by the CPU 202, the main module 220 controls the general operations of the redundant build module 102 while a source program in one or more high-level programming languages is converted into executable code (e.g., a control program or an operating-system program).

In the present embodiment, the compilers 222, 222′ each include substantially the same set of encoded instructions to convert the source program into a corresponding one of two intermediate pieces of code. Similarly, each of code generators 224, 224′ includes substantially the same set of encoded instructions to convert intermediate code from the compilers 222, 222′ into two corresponding collections of object code pieces. The linker modules 226, 226′ are also designed to have substantially the same set of encoded instructions to link the corresponding collection of object code pieces together to form two processor-executable programs (also referred to herein as load modules), which are executable by the program controller 106. As described further herein, the comparison module 228 compares the processor-executable programs, and if both processor-executable programs are substantially the same, the comparison module 228 sends one of them to the programmable controller 106.

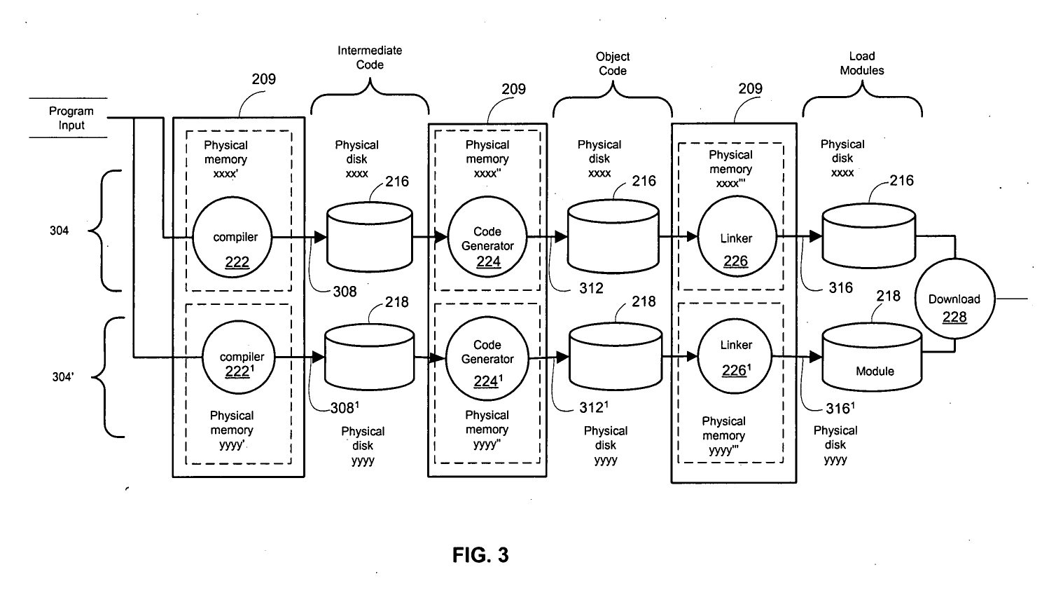

Referring next to FIG. 3, shown is a data flow diagram illustrating the interaction among the program modules of the redundant build module 102 according to an exemplary embodiment. As shown, there are first and second processing chains 304, 304′, each of which includes one of the compilers 222, 222′, one of the code generators 224, 224′ and one of the linker modules 226, 226′. As shown, each of the linker modules 226, 226′ are coupled to the comparison module 228.

Although implemented within a single computer, in the exemplary embodiment the compiler 222, the code generator 224 and the linker 226 in the first processing chain 304 are simultaneously executed from separate portions of RAM 209 than are their functional equivalents in the second processing chain 304′. As shown in FIG. 3, for example, the compiler 222 in the first processing chain 304 is executed in physical memory location xxxx′ of RAM 209 and the compiler 222′ in the second processing chain 304′ is executed in physical memory location yyyy′ of RAM 209. In one embodiment, the compilers 222, 222′ are each placed in a separate Dynamic Link Libraries (DLLs) and launched simultaneously to effectuate the loading of the compilers 222, 222′ into separate portions of RAM 209. In this way, errors from a faulty portion of memory 209 are more likely to affect only one of the compilers 222, 222′. The code generators 224, 224′ and the linkers 226, 226′ are also loaded into and executed from separate portions of RAM 209 in the same manner as the compilers 222, 222′ to help ensure that any malfunction in the memory 209 does not affect both processing chains 304, 304′.

In the exemplary embodiment, the data products (i.e., the intermediate code 308, object code 312, and the load module 316) of the first processing chain 304 are stored in the first hard drive 216 and the data products (i.e., the intermediate code 308′, object code 312′, and the load module 316′) of the second processing chain 304′ are stored in the second hard drive 218. In this way, errors introduced into the data products by one of the storage devices 216, 218 are less likely to affect both processing chains 304, 304′.

To further diversify the hardware associated with the data products of each processing chain, the first and second data storage devices 216, 218 are controlled by separate disk controllers 212, 214 as shown in FIG. 2. For example, one of the disk controllers 212, 214 may be an IDE disk drive controller and the other may be a SCSI disk drive controller. In this way, any errors introduced by one of the disk controllers 212, 214 are less likely to corrupt the data products of both processing chains 304, 304′.

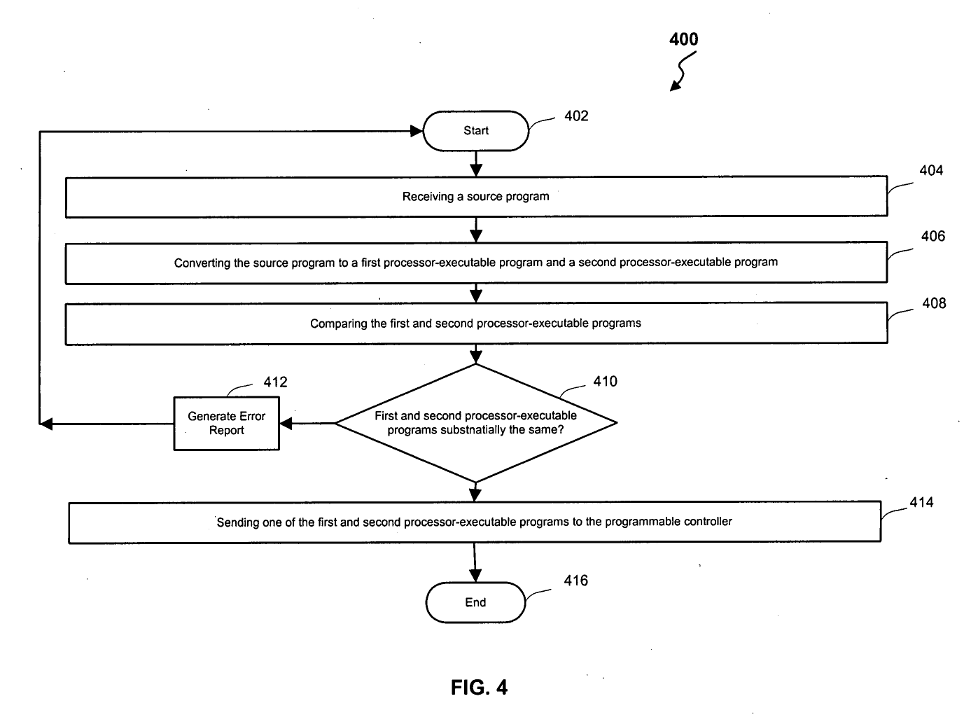

Referring next to FIG. 4, shown is a flowchart depicting steps carried out by the redundant build module 102 when building an executable program from a source program. In operation, the conversion process begins (Step 402) when a user requests that a source program be converted into an executable program. The redundant build module 102 then receives the source program (Step 404), and converts the source program into first and second processor-executable programs (Step 406).

Although the exemplary embodiment described with reference to FIGS. 2 and 3 includes three distinct steps (i.e., compiling, code generating and linking), it is contemplated that one or more of these steps may be dropped altogether or combined into one seamless operation. For example, the source code may be compiled directly into an executable program without generating and storing intermediate code. Moreover, it is contemplated that additional steps may be added to the process of converting a source program into an executable program without departing from the scope of the present invention.

As shown, once first and second processor executable programs are generated, they are compared (Step 408). In the exemplary embodiment described with reference to FIG. 3, the first and second executable programs are output from the first and second processing chains 304, 304′, as first and second load modules 316, 316′. The comparison module 228 then takes each of the load modules 316, 316′, and separates each into manageable pieces that are protected by cyclical redundancy codes (CRCs). In one embodiment, the CRCs are compared to determine whether corresponding pieces of the load modules 316, 316′ are the same. In another embodiment, the load modules 316, 316′ are compared bit-by-bit.

If the first and second executable programs are not substantially the same (Step 410), then an error report is generated for the user, and the process described with reference to Steps 402 through 410 is optionally started over again (Step 412). If the first and second executable programs are substantially the same (Step 410), then either the first or the second executable program is output from the redundant build module 102 and sent to the programmable controller 106 (Step 414). The conversion process is then complete (Step 416).

Although the exemplary embodiment described with reference to FIGS. 2 and 3 separately converts the source program into an executable program with a single processor in a single computer, other implementations of the redundant build module 102 are contemplated and well within the scope of the present invention. In one embodiment for example, the redundant build module 102 includes two processors to further diversify the system resources associated with each of the load modules 316, 316′. In another embodiment, the redundant build module 102 is realized by two separate computers, and each computer separately converts the source program into a corresponding load module 316, 316′. In yet another embodiment, a single computer is used to asynchronously convert the source program into two executable programs so as to temporally separate the conversion of the source program into two load modules 316, 316′.

Although separately converting source programs according to any of the various embodiments of the present invention reduces the likelihood that there will be an error in the executable program sent to the programmable controller 106, the possibility exists that a system error in the redundant build module 102 may manifest itself in exactly the same way in each of the executable programs, and hence, go undetected. To reduce the likelihood that such a system error goes undetected, the system resources of the redundant build module 102 associated with the executable program (i.e., the system resources used to generate the executable program sent to the programmable controller 106) are validated.

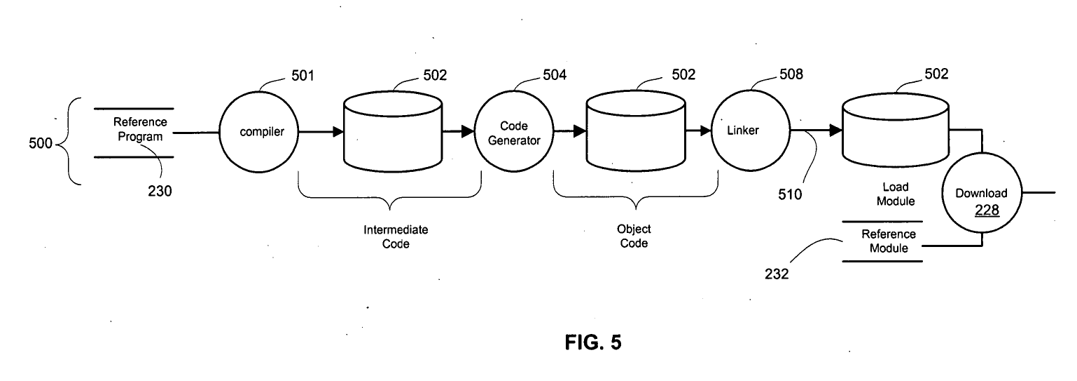

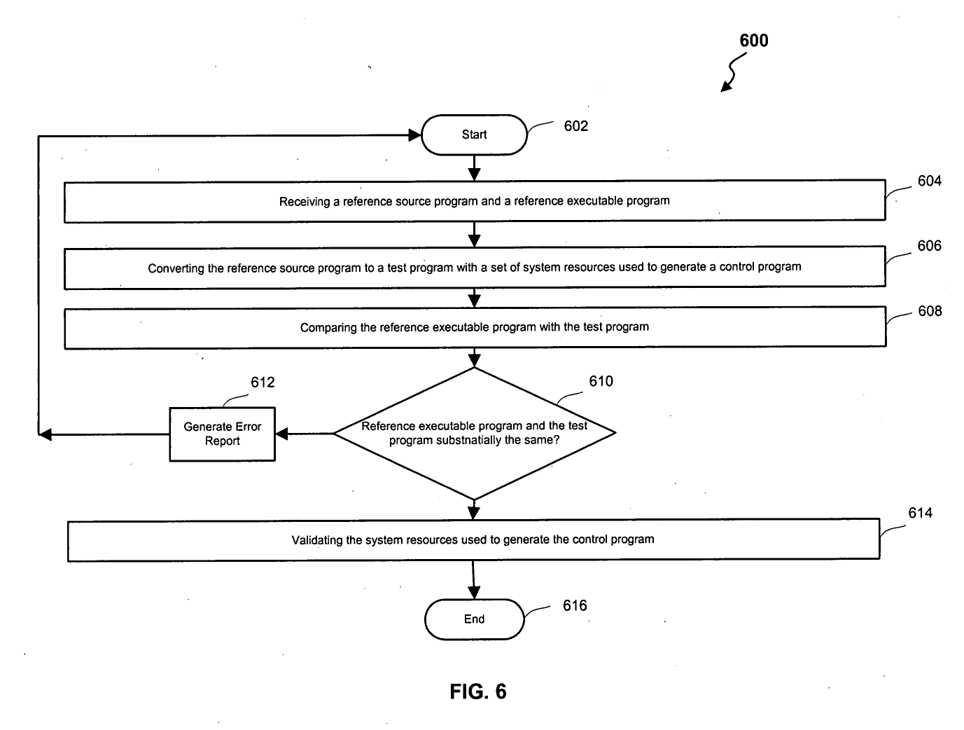

Referring next to FIG. 5, shown is a data flow diagram depicting data flow during a validation of system resources in the redundant build module 102 of FIG. 2. Shown is a processing chain 500 including a compiler 501, a code generator 504 and a linker module 508. In the present embodiment, the processing chain 500 represents one of the processing chains 304, 304′ of FIG. 3 associated with the processor executable code sent to the programmable controller 106. While referring to FIG. 5 simultaneous reference will be made to FIG. 6, which is a flowchart depicting steps carried out during a validation of the resources of the redundant build module 102.

In operation, the validation process is initiated either by the user or automatically by the redundant build module 102 (Step 602). Once initiated, the reference source program 230 and the reference executable program 232 are extracted from the memory 204 (Step 604), and the reference source program 230 is converted into a test program 510 by the processing chain 500 (Step 606). The reference executable program 232 is then compared with the test program 510 (Step 608). If the reference executable program and the test program 510 are not substantially the same (Step 610), then an error report is generated (Step 612) to inform the user that a fault exits within the redundant build module 102. If the reference executable program 232 and the test program 510 are substantially the same (Step 610), then the processing chain 500 of the redundant build module 102 is validated (Step 614), and the validation process is completed (Step 616).

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following Claims and their equivalents define the scope of the invention.

1. A method for building a program for execution by a programmable controller, the method comprising:
receiving a source program, the source program including high-level instructions for controlling a programmable controller;
converting the source program to a first processor-executable program and a second processor-executable program;
comparing the first and second processor-executable programs;
sending, in response to the first and second processor-executable programs being substantially the same, one of the first and second processor-executable programs to the programmable controller.

2. The method of claim 1 wherein the sending includes sending the one of the first and second processor-executable programs to one of a plurality of intelligent field devices, the intelligent field devices including programmable controllers.

3. The method of claim 1 wherein the sending includes sending the one of the first and second processor-executable programs to a modular redundant control system, the modular redundant control system including at least two processor modules, wherein the modular redundant control system distributes the one of the first and second processor-executable programs to the at least two processor modules, and wherein each of the processor modules is configured to carry out instructions encoded in the one of the first and second processor-executable programs.

4. The method of claim 1 wherein the first processor-executable program and the second processor-executable program include encoded instructions for controlling field devices.

5. The method of claim 1 wherein the first processor-executable program and the second processor-executable program include operating-system instructions for controlling the programmable controller.

6. The method of claim 1 including:
loading a first compiler into a first memory location; and
loading a second compiler into a second memory location separate from the first memory location;
wherein the converting includes converting the source program to a first piece of intermediate code with the first compiler and converting the source program to a second piece of intermediate code with the second compiler.

7. The method of claim 6 wherein the first and second memory locations are a part of the same computer.

8. The method of claim 6 wherein the first and second compilers are simultaneously loaded into the first and second memory locations.

9. The method of claim 6 wherein the converting includes storing the first and second pieces of intermediate code in separate disk drives.

10. The method of claim 1 wherein the comparing includes comparing the first and second processor-executable programs bit-by-bit.

11. The method of claim 1 wherein the comparing includes generating a cyclical redundancy code for each of the first and second processor-executable programs, and comparing the cyclical redundancy codes for the first and second processor-executable programs.

12. The method of claim 1 wherein the converting includes converting the source program to the first processor-executable program with a first processor and converting the source program to the second processor-executable program with a second processor.

13. The method of claim 1 wherein the converting includes converting the source program to the first processor-executable program and asynchronously converting the source program to the second processor executable program.

14. The method of claim 1 including:
receiving a reference source program and a reference executable program, wherein the reference executable program includes processor executable code generated on a trusted system from the reference source program;
converting the reference source program to a test program using system resources used to convert the source program to the one of the first and second processor-executable programs;
comparing the reference executable program with the test program; and
validating, in response to the reference executable program and the test program being substantially the same, the system resources used to convert the source program to the one of the first and second processor-executable programs.

15. A system for generating a control program comprising:
a processor;
a network communication module coupled to the processor, wherein the network communication module is configured to communicate with a programmable controller via a network, the programmable controller associated with a safety instrumented function; and
a memory associated with the processor, the memory including:
conversion code including encoded instructions for separately converting a source program into first and second load modules, the first and second load modules including processor-executable code to control the programmable controller; and
comparison code including encoded instructions for comparing the first and second load modules and sending one of the load modules to the programmable controller in response to the first and second load modules being substantially the same.

16. The system of claim 15 wherein the programmable controller is an intelligent field device, and wherein at least one other intelligent field devices is coupled to the network.

17. The system of claim 15 wherein the programmable controller is a main processor in a modular redundant control system, wherein the sending includes sending the one of the load modules to at least one other programmable controller in the modular redundant control system.

18. The system of claim 15 wherein the one of the load modules includes encoded instructions for controlling field devices with the programmable controller.

19. The system of claim 15 wherein the one of the load modules includes operating-system instructions for controlling the programmable controller.

20. The system of claim 15 wherein the conversion code includes encoded instructions for simultaneously generating the first and second load modules using the processor.

21. The system of claim 20 including:
random access memory coupled with the processor;
wherein the conversion code includes encoded instructions to load two copies of a portion of the conversion code into separate portions of the random access memory and simultaneously generate each of the first and second load modules with a corresponding one of the two copies of the portion of the conversion code.

22. The system of claim 15 wherein the conversion code includes encoded instructions to asynchronously generate the first and second load modules using the processor.

23. The system of claim 15 including another processor, wherein the conversion code includes encoded instructions to generate the first load module with the processor and the second load module with the other processor.

24. The system of claim 15 including:
a first storage device coupled to the processor;
a second storage device coupled to the processor;
wherein the conversion code includes encoded instructions to store intermediate code associated with the first load module in the first storage device and store intermediate code associated with the second load module in the second storage device.

25. The system of claim 24 wherein the first and second storage devices are hard drives.

26. The system of claim 24 wherein the first storage device is a local hard drive and the second storage device is a network hard drive.

27. The system of claim 15 wherein the comparison code includes encoded instructions to compare the first and second load modules on a bit-by-bit basis.

28. The system of claim 27 wherein the comparison code includes encoded instructions for sending the one of the load modules to the programmable controller in response to the first and second load modules being identically the same.

29. The system of claim 15 wherein the comparison module includes instructions to generate cyclical redundancy codes for the first and second load modules, and instructions to compare the cyclical redundancy codes for the first and second load modules.

30. The system of claim 15 wherein the memory includes:
a reference source program; and
a reference executable program;
wherein the conversion code includes encoded instructions to convert the reference source program into a test program using system resources associated with the one of the load modules sent to the programmable controller;
wherein the comparison code includes encoded instructions for comparing the test program and the reference executable program, and validating, in response to the test program and the reference executable program being substantially the same, the system resources associated with the one of the load modules sent to the programmable controller.

31. A processor-readable medium including code to generate an executable program from a source program when carried out by a processor, the executable program being disposed for execution by a programmable controller, the code comprising:
conversion code for converting a source program into the executable program;
a code segment for loading two copies of at least a portion of the conversion code into a memory associated with the processor such that the two copies do not occupy the same location in the memory; each of the two copies including code to generate a corresponding one of two copies of at least a portion of the executable program;
comparison code for comparing the two copies of the at least the portion of the executable program, and for sending at least one of the two copies of the at least the portion of the executable program to the programmable controller in response to the two copies of the at least the portion of the executable program being substantially the same.

32. The processor-readable medium of claim 31 wherein the conversion code includes compiler code for converting the source program into intermediate code, and wherein the code for loading two copies of the at least the portion of the conversion code into the memory includes code for loading two copies of the compiler code into the memory such that the two copies of the compiler code do not occupy the same location in memory.

33. The processor-readable medium of claim 32 including:
code for loading a first piece of intermediate code generated by one of the two copies of the compiler code into a first memory location and loading a second piece of intermediate code generated by another one of the two copies of the compiler code into a second memory location.

34. The processor-readable medium of claim 33 wherein each of the first and second memory locations are a part of a corresponding one of a first and second hard drives.

35. The processor-readable medium of claim 34 wherein each of the first and second hard drives are controlled by separate disk controllers.

36. The processor-readable medium of claim 33 wherein each of the first and second memory locations are a part of a corresponding one of a first and second separate RAM memory locations.

37. The processor-readable medium of claim 33 wherein the first memory location is part of a network hard drive and the second memory location is part of a memory location selected from the group consisting of a RAM memory and a local hard drive.

38. The processor-readable medium of claim 31 wherein each of the two copies of at least a portion of the conversion code are in a corresponding one of two dynamic loaded libraries (DLLs), wherein the code for loading the two copies includes code for loading the two copies into the memory simultaneously such that the two copies do not occupy the same location in the memory.

39. The processor-readable medium of claim 31 wherein the comparison code includes code for comparing the two copies of the at least the portion of the executable program on a bit-by-bit basis.

40. The processor-readable medium of claim 31 wherein the comparison code includes:
a code segment for generating a cyclical redundancy code for each of the two copies of the at least the portion of the executable program; and
a code segment for comparing the cyclical redundancy codes for the two copies of the at least the portion of the executable program.

41. The processor-readable medium of claim 31 including:
a reference source program;
a reference executable program, the reference executable program includes processor executable code generated on a trusted system from the reference source program;
wherein the conversion code includes code for converting the reference source program to a test program using system resources used to convert the at least one of the two copies of the at least the portion of the executable program sent to the programmable controller;
wherein the comparison code includes code for comparing the reference executable program with the test program and validating, in response to the reference executable program and the test program being substantially the same, system resources used to convert the at least one of the two copies of the at least the portion of the executable program sent to the programmable controller.

42. A method for building a program for execution by a programmable controller, the method comprising:
receiving a source program, the source program including high-level instructions for controlling a programmable controller, the programmable controller being associated with a safety instrumented function;
converting the source program to a first processor-executable program and a second processor-executable program;
comparing the first and second processor-executable programs;
generating a signal indicative of the similarity between the first and second processor-executable programs.

43. The method of claim 42 including:
loading a first compiler into a first memory location; and
loading a second compiler into a second memory location separate from the first memory location;
wherein the converting includes converting the source program to a first piece of intermediate code with the first compiler and converting the source program to a second piece of intermediate code with the second compiler.

44. The method of claim 43 wherein the first and second memory locations are a part of the same computer.

45. The method of claim 43 wherein the first and second compilers are simultaneously loaded into the first and second memory locations.

46. The method of claim 43 wherein the converting includes storing the first and second pieces of intermediate code in separate disk drives.

47. The method of claim 42 wherein the first processor-executable program and the second processor-executable program include encoded instructions for controlling field devices associated with the safety instrumented function.

48. The method of claim 42 wherein the first processor-executable program and the second processor-executable program include operating-system instructions for controlling the programmable controller.
